(19) United States
(12) Patent Application Publication
(10) Pub. No.: US 2008/0043393 A1
(43) Pub. Date: Feb. 21, 2008

(54) Power switching device

(75) Inventor: Plamen Petkov, Mississauga (CA)

Correspondence Address: Oral Caglar;HONEYWELL INTERNATIONAL, Law Department AB 2, P.O. Box 2245, Morristown, NJ, 07962-9806, US

(73) Assignee: HONEYWELL INTERNATIONAL INC.

(21) Appl. No.: 11/505,854

(22) Filed: Aug. 18, 2006

(51) Int. Cl. H02H 5/04

(52) U.S. Cl. 361/103

(57) ABSTRACT

A method and power switching devices protect AC and DC electric systems. A power switching device (80) according to one embodiment comprises: a sensing unit for sensing a current signal; an analysis unit (130) for extracting a parameter using a temperature measurement relating to the sensing unit, the parameter being based on a square of the current signal; an integrator unit (230) for integrating the parameter in time, to obtain an integrator value; and a trip unit (240) for detecting a trip condition by comparing the integrator value with a rated trip value.

### BACKGROUND OF THE INVENTION

1. Field of the Invention

The present invention relates to electric power systems, and more particularly to a method and apparatus for protecting electric circuits during abnormal load conditions.

2. Description of the Related Art

Electrical systems used in complex environments such as aerospace systems, industrial environments, vehicles, and residential environments include a large number of electrical circuits, devices, and wires. Overload and abnormal load conditions may occur in any of the electrical circuits, or along the wires. If not detected promptly, overload and abnormal load conditions may cause short circuits, malfunctions, and fires in the equipment serviced by the electrical circuits or wires exhibiting overload or abnormal load conditions.

Detection and protection from overload and abnormal load conditions pose a significant challenge in such complex environments. Correct and prompt overload and abnormal load condition detection and protection are critical in aircraft environments, for example.

Typical/conventional short circuit protection systems provide short circuit protection by limiting chopping current and commanding thermal shutdown for gross over-temperature conditions, or by implementing current limiting circuits with latching-off capabilities. These short circuit protection systems protect the switching devices, however, they do not protect the downstream circuits.

More advanced solid-state relays offer I²*t protection, by which the trip time is inversely proportional to the square of the current through the solid-state relays. Such solid-state relays typically use a current sense device such as a shunt resistor, together with sophisticated signal processing circuitry such as analog multipliers, microcontrollers, or digital signal processors (DSPs), to calculate the running Root Mean Square (RMS) value of the current, subtract the rated current from the RMC value, and compare the result with a trip limit. These protection systems are rather complex, which makes them prohibitively expensive for use in many applications. Moreover, due to the complexity of these protection systems, multiple errors can arise from the large number of devices used to implement the I²*t protection.

Disclosed embodiments of the application addresses these and other issues by utilizing power switching devices and methods that performs I²*t protection without acquiring current and performing non-linear analog conversions. The power switching devices and methods perform I²*t protection for both AC and DC applications using an I²*t calculation, based on a temperature measurement and a time integration.

### SUMMARY OF THE INVENTION

The present invention is directed to a method and power switching devices that protect AC and DC electric systems. According to a first aspect of the present invention, a power switching device comprises: a sensing unit for sensing a current signal; an analysis unit for extracting a parameter using a temperature measurement relating to the sensing unit, the parameter being based on a square of the current signal; an integrator unit for integrating the parameter in time, to obtain an integrator value; and a trip unit for detecting a trip condition by comparing the integrator value with a rated trip value.

According to a second aspect of the present invention, a power switching device comprises: a filament bulb sensing a DC current and an AC current, the resistance of the bulb being dependent on temperature of the filament of the bulb; a low pass filter connected to the bulb, the low pass filter producing an output DC voltage proportional to the resistance of the bulb; a trip unit for detecting a trip condition by comparing the output DC voltage with a bulb voltage at a rated current; and a power switch connected to the bulb, wherein the power switch is shut off when the output DC voltage is larger than the bulb voltage at the rated current.

According to a third aspect of the present invention, a power switching device comprises: a sensing unit for sensing a current signal; an analysis unit for extracting a parameter using a temperature measurement relating to the sensing unit, the parameter being based on a square of the current signal; and a decision module for detecting a trip condition, the decision module detecting a trip condition by obtaining a time-integrated value of the parameter in time using an exponential time dependence relating to the parameter, and a thermal inertia associated with at least one of the sensing unit and the analysis unit, and detecting a trip condition by comparing the time-integrated value with a rated trip value.

According to a fourth aspect of the present invention, a method for protection for AC and DC electric systems comprises: sensing a current signal; extracting a parameter using a temperature measurement relating to heating caused by the current signal, the parameter being based on a square of the current signal; integrating the parameter in time, to obtain an integrator value; and detecting a trip condition by comparing the integrator value with a rated trip value.

### BRIEF DESCRIPTION OF THE DRAWINGS

Further aspects and advantages of the present invention will become apparent upon reading the following detailed description in conjunction with the accompanying drawings, in which:

FIG. 1 is a block diagram of an electrical system containing a power switching device according to an embodiment of the present invention;

FIG. 2 is a block diagram of a power switching device according to an embodiment of the present invention;

FIG. 3 is a block diagram of an exemplary power switching device according to an embodiment of the present invention illustrated in FIG. 2;

FIG. 4 is a block diagram of an exemplary power switching device with externally defined rating settings according to an embodiment of the present invention illustrated in FIG. 2;

FIG. 5 is a block diagram of an exemplary power switching device with external resistors setting rating levels according to an embodiment of the present invention illustrated in FIG. 2;

FIG. 6 is a block diagram of an exemplary power switching device using exponential time integration according to an embodiment of the present invention illustrated in FIG. 2; and

FIG. 7 is a block diagram of a temperature analysis module for a power switching device according to a second embodiment of the present invention illustrated in FIG. 2.

### DETAILED DESCRIPTION

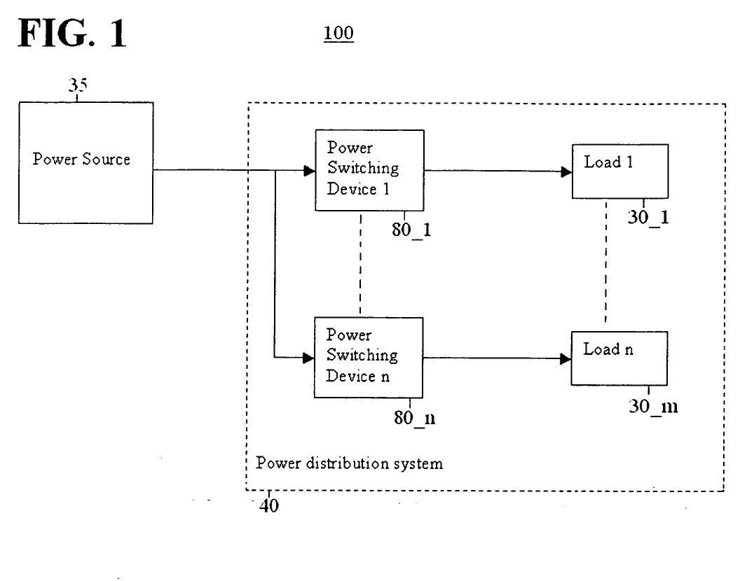

Aspects of the invention are more specifically set forth in the accompanying description with reference to the appended figures. FIG. 1 is a block diagram of an electrical system containing a power switching device according to an embodiment of the present invention. The electrical system 100 illustrated in FIG.1 includes the following components: a power source 35; and a power distribution system 40 including power switching devices 80_1, 80_2, . . . , 80_n and loads 30_1, 30_2, . . . , 30_m. Operation of the electrical system 100 in FIG. 1 will become apparent from the following discussion.

Electrical system 100 may be associated with an aircraft, a ship, a laboratory facility, an industrial environment, a residential environment, etc. The power source 35 provides electrical energy in electrical system 100. The power source 35 may provide AC power, DC power, or both AC and DC power. The power source 35 may include a generator of a vehicle, a turbine, a generator for an industrial facility, a motor, a battery etc., as well as electrical circuits and components such as transformers, rectifiers, filters, battery banks, etc. The power source 35 provides power to power distribution system 40.

Power distribution system 40 receives electric power from power source 35, and distributes it to loads 30_1, . . . , 30_m. Loads 30_1, . . . , 30_m are electric circuits that enable functioning of various services onboard a vehicle, an aircraft, or in a complex environment such as a laboratory facility. Loads 30_1, . . . , 30_m may use AC or DC power, or both. Such loads may be an electric motor, an automatic braking system, an air conditioning system, a lighting system of a vehicle, a piece of industrial equipment, etc.

Power switching devices 80_1, 80_2, . . . , 80_n protect power source 35, loads 30_1, . . . , 30_m, and other circuits in power distribution system 40, during normal and abnormal electric and load conditions. Power switching devices 80_1, 80_2, . . . , 80_n can detect abnormal electric behavior such as overcurrents, overloads, arcs, etc., in electronic components included in power source 35, loads 30_1, . . . , 30_m, and other circuits included in power distribution system 40.

Upon detecting abnormal electric behavior such as overcurrents, overloads, arcs, etc., in modules of electrical system 100, one or more of the power switching devices among 80_1, 80_2, . . . , 80_n command a switch off of the modules associated with the abnormal electric behavior. Hence, power switching devices 80_1, 80_2, . . . , 80_n protect themselves, as well as power source 35 and loads 30_1, . . . , 30_m, from abnormal electric conditions.

Fuses, Solid State Power Controllers (SSPCs), arrestors, transorbs, circuit breakers, sensing equipment, circuit interrupters, wires, etc., included in power source 35 and power distribution system 40 can help in detection and protection from abnormal electric behavior and load conditions.

Although the systems in electrical system 100 are shown as discrete units, it should be recognized that this illustration is for ease of explanation and that the associated functions of certain functional modules can be performed by one or more physical elements.

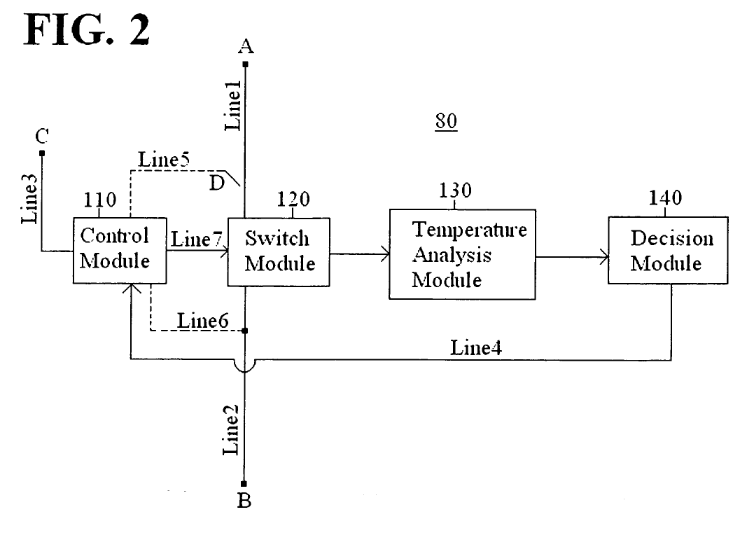

FIG. 2 is a block diagram of a power switching device 80 according to an embodiment of the present invention. The block diagram for the power switching device 80 in FIG. 2 describes the power switching devices 80_1, 80_2, . . . , 80_n in FIG. 1. Power switching device 80 illustrated in FIG. 2 includes the following components: a switch module 120; a temperature analysis module 130; a decision module 140; and a control module 110.

Switch module 120 connects to loads in power distribution system 40, through Lines 1 and 2 at contacts A and B. Switch module 120 may sense currents and/or voltages from AC or DC loads to which it is connected. Switch module 120 may include electric and electronic components such as MOSFET transistors, BJT transistors, circuits with multiple FETs, other transistor types, resistors, capacitors, solid state circuit breakers, switches, circuit breakers, etc.

Temperature analysis module 130 analyzes one or more temperature parameters relating to the switch module 120. Temperature analysis module 130 uses the analyzed temperatures, as well as one or more parameters from the switch module 120, to obtain and output a parameter relating to the electrical operation of switch module 120. Temperature analysis module 130 may include thermo-electric and electronic components such as thermocouples, amplifiers, sensors, microprocessor-based electronics, etc.

Decision module 140 receives the parameter relating to the switch module 120 operation from temperature analysis module 130, and outputs a decision on whether an overload or abnormal load condition exists in the circuits connected at contact points A and B. Decision module 140 may include electric and electronic components such as op-amps, comparators, feedback loops, resistors, capacitors, etc.

Control module 110 controls the switch module 120 through electrical Lines 5, 6, and 7. Control module 110 receives from decision module 140, through Line 4, the decision regarding existence of overload or abnormal load conditions. Control module 110 may then change the operating state of switch module 120. Control module 110 may implement additional protection techniques through electrical Lines 5 and 6. Control module 110 may also receive input or commands from other systems, or from human operators, through Line 3 at contact C. Control module 110 may include microprocessor-based electronics, logic circuits, current and voltage measurement devices, etc.

Switch module 120, temperature analysis module 130, decision module 140, and control module 110 may include electrical components and circuits, memories, and can be implemented in ASIC chip, FPGA, with microcontroller, etc.

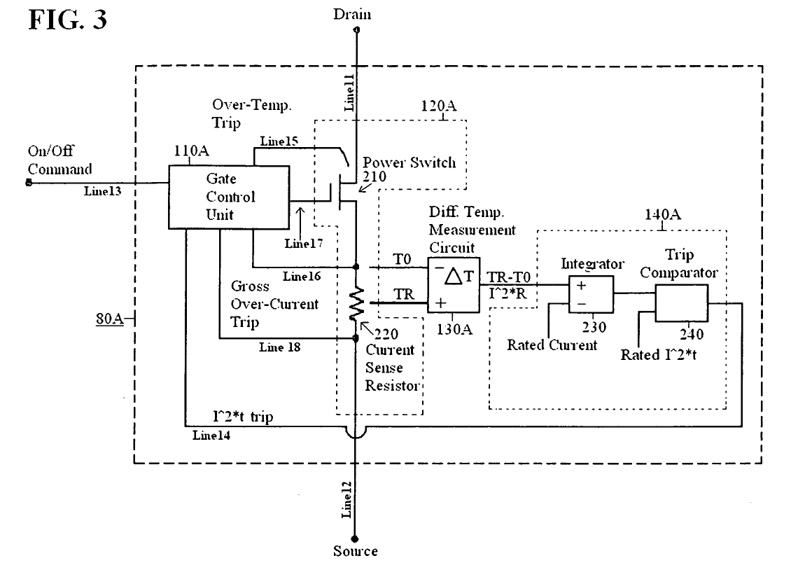

FIG. 3 is a block diagram of an exemplary power switching device 80A according to an embodiment of the present invention illustrated in FIG. 2. As illustrated in FIG. 3, the power switching device 80A includes the following components: a power switch 210; a current sense resistor 220; a gate control unit 110A; a differential temperature measurement circuit 130A; an integrator 230; and a trip comparator 240. Power switch 210 and current sense resistor 220 are included in a switch module 120A. Integrator 230 and trip comparator 240 are included in a decision module 140A. Gate control unit 110A is a control module as illustrated in FIG. 2.

As illustrated in FIG. 3, power switch 210 may be MOSFET transistor with its source and drain connected to loads in electrical system 100, and its gate connected to gate control unit 110A. Other devices and circuits, such as BJT transistors, circuits with multiple FETs, etc., may also be used for power switch 210.

Gate control module 110A controls the power switch 210 through electrical Line 17. Gate control unit 110A performs On/Off control of power switch 210. Gate control unit 110A may also receive input or On/Off commands from other systems, or from human operators, through Line 13. Gate control unit 110A may include microprocessor-based electronics, logic circuits, current and voltage measurement devices, etc.

Current sense resistor 220 is a resistor connected in series with the power switch 210, hence the current trough the current sense resistor 220 is also the current through power switch 210 (between Source and Drain points). Load circuits that power switching device 80A protects are connected to power switching device 80A at Lines 11 and 12 (Source and Drain points).

Differential temperature measurement circuit 130A senses temperatures and performs differential measurements of sensed temperatures. Differential temperature measurement circuit 130A may include thermo-electric and electronic components such as thermocouples, amplifiers, sensors, microprocessor-based electronics, etc.

Integrator 230 performs integration, such as time integration, of various input parameters. Integrator 230 includes electronic components such as op-amp amplifier circuits, feedback loops, capacitors, resistors, etc.

Trip comparator 240 compares two input parameters, and outputs a third parameter related to magnitudes of the input parameters. The trip comparator 240 may include electronic components such as comparators, resistors, capacitors, etc.

The power switching device 80A combines in a single power switching device a switch, a current sense resistor, overcurrent and thermal protection, with additional thermosensing and processing circuitry. The power switching device 80A, including the power switch 210 with current sense resistor 220, performs current sense resistor-based gross over-current protection and over-temperature protection. The differential temperature measurement circuit 130A, integrator 230, and trip comparator 240 perform I²*t protection. Gate control unit 110A accommodates gross over-current and over-temperature protection, as well as I²*t control, by communicating with the I²*t trip comparator 240.

Under steady conditions, the internal current sense resistor 220 experiences a temperature rise with respect to the surrounding environment, proportional to the dissipated power P=I²*R_{elec}, where R_{elec} is the electrical resistance of current sense resistor 220, and I is the current flowing through current sense resistor 220. The temperature rise ΔT of the current sense resistor 220 with respect to the surrounding environment is related to the dissipated power in the resistor, by the relationship

$$\frac{Q}{t} = \frac{Δ T}{{R}_{th}} ,$$

where Q is dissipated heat, t is time, and Rₜₕ is the thermal resistance of the current sense resistor 220.

$$\frac{Q}{t}$$

is dissipated power P, for which P=I²*R_{elec}. In conclusion, a proportionality relationship exists between temperature rise ΔT of the current sense resistor 220, and square of the electrical current:

$$P = {I}^{2} * {R}_{elec} = \frac{Δ T}{{R}_{th}} .$$

The thermal resistance Rₜₕ typically depends on size, shape and other design related parameters of current sense resistor 220. Hence, the temperature rise ΔT of the current sense resistor 220 typically depends on size, shape and other design related parameters of current sense resistor 220. The thermal resistance of the current sense resistor 220 is design dependent, and scales the overall conversion factor from a square of load current to a system value representing the thermal gradient.

The power switching device 80A detects overload and abnormal conditions using a measurement of the temperature rise of current sense resistor 220. Differential temperature measurement circuit 130A senses and measures the temperature rise of current sense resistor 220.

For this purpose, differential temperature measurement circuit 130A performs differential measurement of the temperature of the current sense resistor 220, TR, with respect to the temperature of an adjacent area, T0. The current sense resistor 220, which may already be used in a separate role for gross over-current protection, is used in power switching device 80A to make trip time inversely proportional to square of current. Differential temperature measurement circuit 130A may use two thermo-sensors in differential way. For example, two thermo-sensors may be used for subtraction of temperatures. One of the two thermo-sensors may also be used for thermal protection of the power switching device 80A.

Differential temperature measurement circuit 130A may also directly sense the temperature gradient for current sense resistor 220 by using, for example, a thermo-couple. The thermo-couple may be located at the middle of the current sense resistor 220, which represents the hot end. A cold junction may be placed at one of the ends of current sense resistor 220, or at another cold spot in the circuit for power switching device 80A.

Differential temperature measurement circuit 130A may also perform thermo-sensing based on a voltage drop across thermo-resistors or across forward polarized P-N junctions such as diodes or bipolar junction transistors, etc. In this case, a pair of thermo-sensing devices is used, with one device placed at the center of current sense resistor 220, and the other device placed at one end of the current sense resistor 220.

Differential temperature measurement circuit 130A sends the results of differential temperature measurement to integrator 230, which subtracts an offset signal from the differential temperature measurement. The offset represents the temperature rise at rated current of power switching device 80A. The offset signal of integrator 230 is related to the rated current, which is the threshold above which a trip timing will start. The rated current for integrator 230 is the rated current for the load protected by power switching device 80A. The rated current for the load may be varied within some limits that depend on the power switching device capability.

The offset signal of integrator 230 may be the rated current, or other thresholds related to the rated current. For example, the offset signal of integrator 230 may be a voltage corresponding to the rated current, through a square function for example; a rated temperature difference corresponding to the rated current, through a linear function for example; etc. The output of the differential temperature measurement circuit 130A may be a voltage output, a current output, etc., proportional to the measured temperature difference TR-T0. The integrator 230 then subtracts the offset signal from the output of the differential temperature measurement circuit 130A. For example, if the output of differential temperature measurement circuit 130A is a voltage proportional to TR-T0, then integrator 230 compares and subtracts voltages corresponding to actual and rated current (through a square function), or to actual and rated temperature difference (through a linear function). The resultant signal represents the square of the current above nominal current, or a resultant value proportional to the square of the current above nominal current. Since the temperature rise of a body (above ambient temperature) is proportional to the dissipated power, the proportionality constant for the resultant value is dependent on thermal properties, which are design related, and on the electrical resistance of the current sense resistor 220. Variation in thermal properties or in electrical resistance of the current sense resistor 220 will result in variations of the “trip limit” i.e. the load current above which a trip timing will begin.

Below rated current, the temperature rise of the current sense resistor 220 will be below the temperature rise at rated current, hence the integrator 230 will be held at its minimum level. Once the current through current sense resistor 220 exceeds the rated current, the integrator 230 sees a positive signal and moves towards the trip point at a speed proportional to temperature rise above temperature at rated current. Integrator 230 integrates the square of the current above nominal current over time, and sends the integration result ƒI²dt to trip comparator 240.

Trip comparator 240 compares the integration result ƒI²dt with the trip limit given by the rated limit (I²*t)_{Rated}. The rated limit (I²*t)_{Rated} for the trip comparator 240 is the rated limit (I²*t)_{Rated} for the load protected by power switching device 80A. The rated limit (I²*t)_{Rated} for the load may be varied within some limits that depend on the power switching device capability.

If the integration result ƒI²dt is above the trip limit (I²*t)_{Rated}, trip comparator 240 sends a I²*t trip report to gate control unit 110A on Line 14. Gate control unit 110A can then apply the appropriate voltage to the gate of power switch 210 on Line 17, to turn the power switch 210 off and thus stop the flow of current between the Drain and the Source (on Lines 11 and 12) of power switch 210. The flow of current is thus stopped in the load circuits that power switching device 80A protects.

The current trough the current sense resistor 220 is also the current through power switch 210 (between Source and Drain points) and through the load circuits that power switching device 80A protects. Since the current sense resistor 220 temperature rise is proportional to the square of the current passing trough the current sense resistor 220, the power switching device 80A enforces I²*t protection without actually acquiring and processing the current.

The current sense resistor 220 can additionally be used for gross overcurrent protection and/or other conventional protection techniques. For example, gate control unit 110A may perform gross over-current protection by measuring current through current sense resistor 220 on Lines 16 and 18, and identifying gross over-current trips. Gate control unit 110A may also perform over-temperature protection by sensing over-temperature on Line 15.

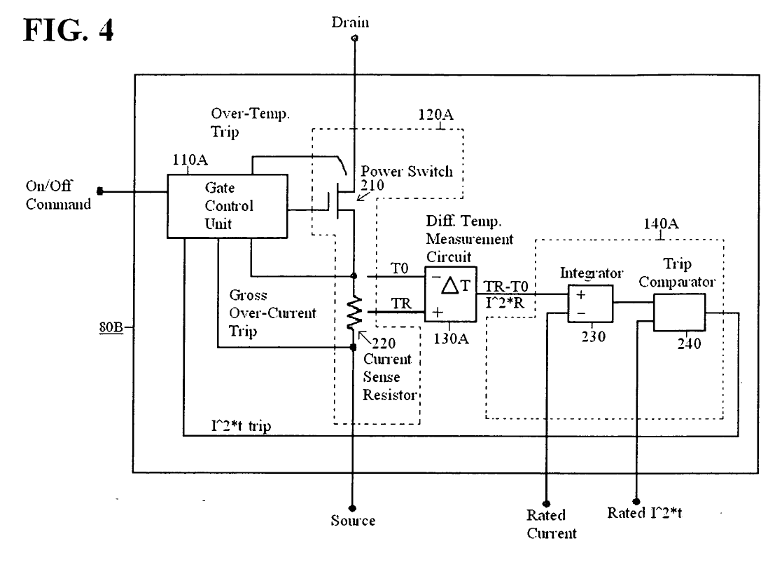

FIG. 4 is a block diagram of an exemplary power switching device 80B with externally defined rating settings according to an embodiment of the present invention illustrated in FIG. 2. As illustrated in FIG. 4, the power switching device 80B includes the following components: a power switch 210; a current sense resistor 220; a gate control unit 110A; a differential temperature measurement circuit 130A; an integrator 230; and a trip comparator 240. Power switch 210 and current sense resistor 220 are included in a switch module 120A. Integrator 230 and trip comparator 240 are included in a decision module 140A. Gate control unit 110A is a control module as illustrated in FIG. 2.

The power switching device 80B in FIG. 4 is similar and functions in a similar manner to power switching device 80A in FIG. 3. Unlike the power switching device 80A in FIG. 3, however, the power switching device 80B in FIG. 4 has the rating setting inputs defined externally, by providing, for instance, voltage levels derived from reference voltages. The rated current setting for integrator 230 and the rated I²*t value for trip comparator 240 are defined externally. The reference voltages used for defining the rated current setting threshold for integrator 230 and the rated I²*t threshold value for trip comparator 240 could be internal or external. Rating setting inputs can be defined externally by, for example, connecting to the device pins external voltages, resistors, etc., connecting to systems outside power switching device 80B, etc. Defining rating setting inputs externally allows flexibility in rescaling the power switching device 80B for specific applications.

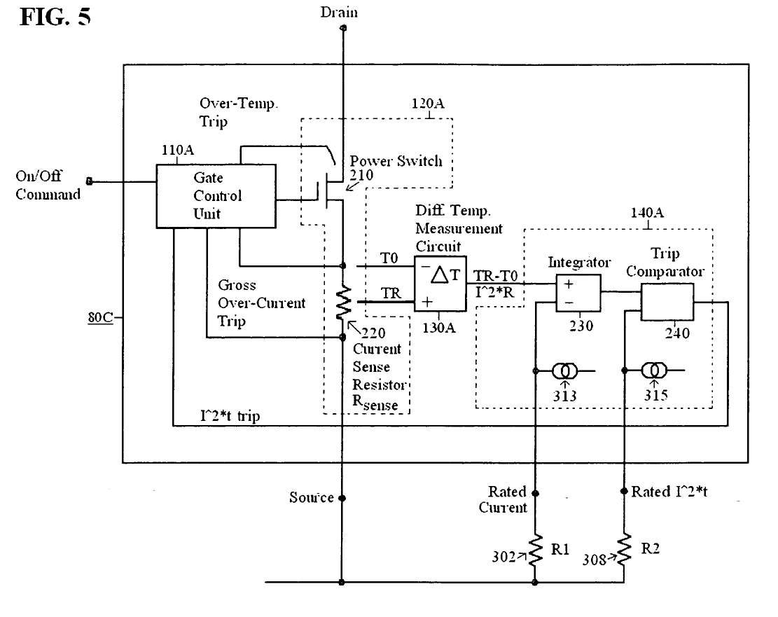

FIG. 5 is a block diagram of an exemplary power switching device 80C with external resistors setting rating levels according to an embodiment of the present invention illustrated in FIG. 2. As illustrated in FIG. 5, the power switching device 80C includes the following components: a power switch 210; a current sense resistor 220; a gate control unit 110A; a differential temperature measurement circuit 130A; an integrator 230; a trip comparator 240; a DC current bias source 313; and a DC current bias source 315. Power switch 210 and current sense resistor 220 are included in a switch module 120A. Integrator 230 and trip comparator 240 are included in a decision module 140A. Gate control unit 110A is a control module as illustrated in FIG. 2.

The power switching device 80C in FIG. 5 is similar and functions in a similar manner to power switching device 80A in FIG. 3. Unlike the power switching device 80A in FIG. 3, however, the power switching device 80C in FIG. 5 has the rating setting levels defined by external resistors 302 R1 and 308 R2 and by internal current settings. External resistor 302 sets the rated current setting for integrator 230. External resistor 308 R2 sets the rated I²*t value for trip comparator 240. Internal constant currents are provided with DC current bias sources 313 and 315, to polarize the rate defining electronic pins of integrator 230 and trip comparator 240.

Defining rating setting inputs using external resistors allows flexibility in rescaling the power switching device 80C for specific applications.

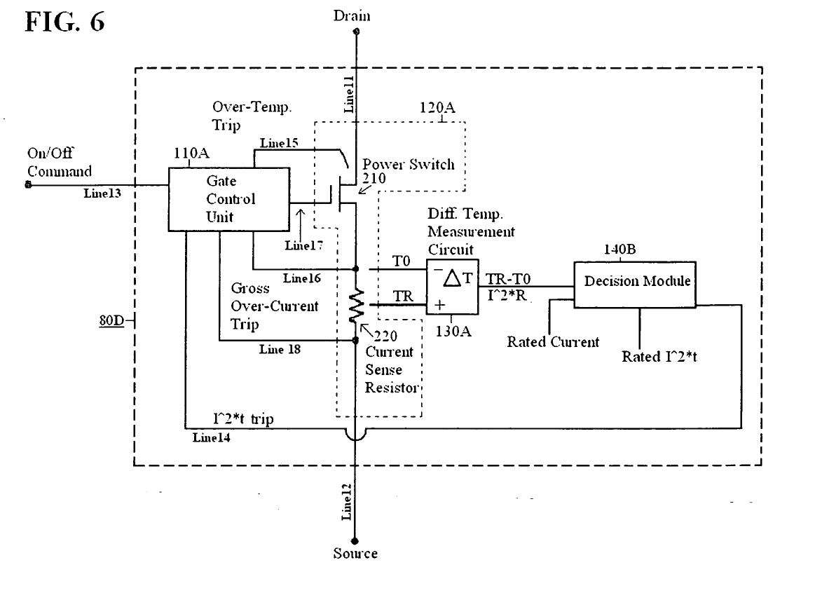

FIG. 6 is a block diagram of an exemplary power switching device 80D using exponential time integration according to an embodiment of the present invention illustrated in FIG. 2. The circuit in FIG. 6 omits the integrator 230, while still retaining the power switching functions. This is achievable when thermal inertia of the current sense resistor 220 and of the temperature sensors that sense the temperature of the current sense resistor 220 is small enough.

As illustrated in FIG. 6, the power switching device 80D includes the following components: a power switch 210; a current sense resistor 220; a gate control unit 110A; a differential temperature measurement circuit 130A; and a decision module 140B. Power switch 210 and current sense resistor 220 are included in a switch module 120A. Gate control unit 110A is a control module as illustrated in FIG. 2.

The rated current and the rated I²*t value are thresholds for the decision module 140B. The higher the dissipated power in the current sense resistor 220, the faster the signal proportional to the temperature rise of resistor 220 will reach the trip level. In this case, the I²*t value is defined by thermal properties such as thermal capacity, which is the energy needed to raise the temperature of a system by one degree.

Differential temperature measurement circuit 130A obtains a signal proportional to the differential temperature measurement from current sense resistor 220. The signal may be a voltage, a current, etc. When the signal is a voltage, this voltage, which is proportional to the differential temperature signal, rises exponentially as described by equation (1):

V(t)=Vmax(1−e^{(-t/τ)}) (1)

where V(t) is the voltage as a function of time t, Vmax is the voltage reached after a sufficient settling time, and τ is a time constant defined by the thermal capacity of current sense resistor 220 and other thermal parameters of power switching device 80D.

Below rated current, V(t) will reach a level below trip point, and the power switching device 80D will not trip. At rated current, V(t) will reach the trip level (Vmax_trip) after a sufficiently long time, but not cross it. At higher than rated current, that is, when Vmax>V_trip, the exponent will rise towards a value higher than the trip limit voltage V_trip and cross the V_trip value within a time t, given by equation (2):

t=−τ*(ln(1−Ut/Umax)) (2)

where t is the time to reach the trip limit, τ is the time constant defined by the thermal capacity, Ut is the trip voltage level (Ut=V_trip), and Umax is the max settled voltage Vmax value for the given current.

A passive RC integrator including a resistor R and a capacitor C, follows the same exponential equation (equation (1)). Hence, the thermal “integrator” of equation (1) behaves like a simple RC integrator. Decision module 140B uses the thermal “integrator” of equation (1) to obtain an I²*t value, and then compare it with a (I²*t)_{rated} value, to determine if a trip has occurred. Unlike an ideal integrator that rises linearly, the thermal integrator rises exponentially, i.e. it saturates after some time. The exponent of equation (1) has a linear section at the beginning, when t<<τ. This linear section behaves like an ideal integrator, one that rises linearly. When the settled temperature rise, obtained after a sufficient settling time, is significantly above the trip level Ut, the curved section of the exponential Vmax(1−e^{(-t/τ)} of equation (1) is beyond the trip point, while the linear section of the exponential Vmax(1−e^{(-t/τ)} is below the trip point. Hence, the nonlinearity error of equation (1), when used as an integrator, is tolerable.

For high current AC applications, a current transformer may be used instead of the current sense resistor 220, in FIGS. 3, 4, 5, and 6. In that case, the thermal gradient of a burden resistor of the current transformer may be used by differential temperature measurement circuit 130A.

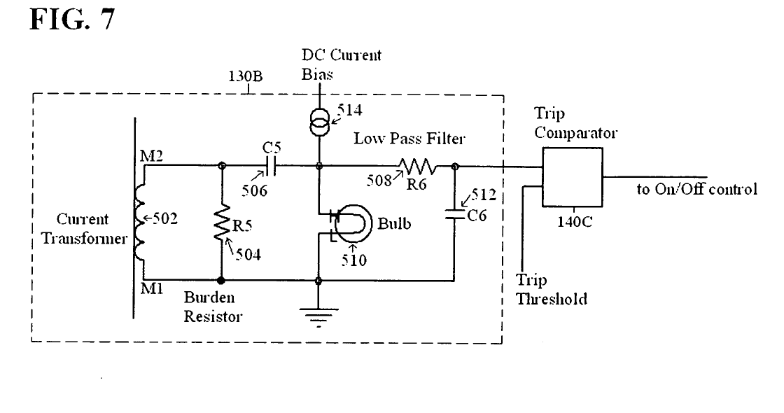

FIG. 7 is a block diagram of a temperature analysis module 130B for a power switching device according to a second embodiment of the present invention illustrated in FIG. 2. As illustrated in FIG. 7, the temperature analysis module 130B includes the following components: a current transformer 502; a burden resistor 504 R5; a capacitor 506 C5; a bulb 510; a low pass filter including a resistor 508 R6 and a capacitor 512 C6; and a DC current bias 514. The output of the low pass filter is connected to a trip comparator 140C. The output of trip comparator 140C is sent to a control module 110 (not shown) that controls a switch module 120 (not shown), as illustrated in FIG. 2.

The temperature analysis module 130B in FIG. 7 provides single, non-differential temperature sensing. The bulb 510 is used as a temperature sensing element. The bulb 510 may be a filament micro-bulb. Other electric or electronic elements may also be used as temperature sensing elements instead of bulbs.

During operation of temperature analysis module 130B, the bulb 510 is preheated to a suitable operating point by a constant DC current from DC current bias 514. An AC current is fed to bulb 510 as well, through the current transformer burden resistor 504 R5. A current sense amplifier may be used instead of the burden resistor, to feed AC current to bulb 510. The resistance of bulb 510 is dependent on its filament temperature: the bulb filament resistance linearly rises with temperature, which in turn is a function of power I²R_{bulb}. The AC current through the bulb heats the filament, hence changing its resistance. The filament temperature is set by the combined effects of the DC and AC currents passing through bulb 510, however the DC current is selected to have a small value with a negligible heating effect.

The low pass filter including resistor 508 R6 and capacitor 512 C6 outputs a DC voltage I_{dc}R_{bulb}; proportional to the resistance of bulb 510. A trip threshold is defined at the trip comparator 140C. The trip threshold represents the bulb voltage at rated current (with a margin of error). When the current through bulb 510 exceeds the rated current for the power switching device, the bulb 510 is heated above the threshold point and the trip comparator will respond and detect a trip condition. Because a micro-bulb filament has a relatively high filament operating temperature, the ambient temperature does not cause errors on bulb temperature measurement.

The heated bulb filament temperature is much larger that the ambient temperature, so the effect of the ambient temperature on the temperature rise of the bulb filament is limited. Errors to bulb temperature measurement due to ambient temperature will in fact reduce trip current at high temperatures, which is beneficial for reliability of the switch module 120. This is because the higher the ambient temperature, the higher is the bulb filament temperature at the same current. Hence, a lower current is required to reach the same trip level at a higher ambient temperature than at a lower ambient temperature.

A current sense amplifier may be used instead of the current transformer 502, to provide the AC current for bulb 510. The current sense amplifier can sense a voltage across a current sense resistor, and produce an AC current. Such a current sense amplifier may be, for example, a high common-mode voltage difference amplifier INA117, a high common mode voltage difference amplifier AD629, etc. An INA117 amplifier is described in the “Electronic Datasheet for High Common-Mode Voltage Difference Amplifier INA117”, from Burr-Brown/Texas Instruments, the entire contents of which are herein incorporated by reference. An AD629 amplifier is described in the “Electronic Datasheet for High Common Mode Voltage Difference Amplifier AD629”, from Analog Devices, the entire contents of which are herein incorporated by reference.

Power switching devices according to embodiments of the present application implement I²*t protection without actually acquiring current and performing non-linear analog conversions; complement I²*t protection with gross over-current trip circuitry; provide protection for AC and DC applications; withstand normal and abnormal load conditions, and protect themselves as well as external loads; perform I²*t protection using an I²*t calculation based on a temperature measurement and a time integration.

Aspects of the present invention are applicable to a wide variety of environments, including aerospace systems, laboratory facilities, vehicle systems, home protection systems, etc.

I Claim:

1. A power switching device, said power switching device comprising:
a sensing unit for sensing a current signal;
an analysis unit for extracting a parameter using a temperature measurement relating to said sensing unit, said parameter being based on a square of said current signal;
an integrator unit for integrating said parameter in time, to obtain an integrator value; and
a trip unit for detecting a trip condition by comparing said integrator value with a rated trip value.

2. The power switching device according to claim 1, further comprising:
a power switch connected to said sensing unit, wherein said current signal passes through said power switch, and said power switch is turned off when said trip unit detects a trip condition wherein said integrator value is larger than said rated trip value.

3. The power switching device according to claim 2, further comprising:
a control unit connected to said power switch and to said trip unit, said control unit turning said power switch off when said trip unit detects a trip condition wherein said integrator value is larger than said rated trip value.

4. The power switching device according to claim 3, wherein said control unit turns said power switch off when said control unit detects gross over-current in said sensing unit.

5. The power switching device according to claim 3, further comprising:
an over-temperature protection switch connected to said control unit and to said sensing unit, said over-temperature protection switch opening when an over-temperature condition occurs in said power switching device, said control unit sensing said opening of said over-temperature protection switch and turning off said power switch.

6. The power switching device according to claim 1, wherein said power switching device is connected to an electrical system and protects said electrical system from overload conditions.

7. The power switching device according to claim 1, wherein said sensing unit comprises a resistor.

8. The power switching device according to claim 1, wherein
said temperature measurement relating to said sensing unit is a differential temperature measurement between a temperature of said sensing unit obtained by heating said sensing unit with said current signal, and a reference temperature, and
said analysis unit extracts a square of said current signal using a proportionality between said differential temperature measurement and said square of said current signal.

9. The power switching device according to claim 1, wherein said integrator unit integrates said parameter in time to obtain an integrator value when said current signal is larger than a rated current signal.

10. The power switching device according to claim 9, wherein said rated current signal and said rated trip value are set internally in said power switching device.

11. The power switching device according to claim 9, wherein said rated current signal and said rated trip value are defined externally of said power switching device, by providing voltage levels derived from a reference voltage.

12. The power switching device according to claim 9, wherein said rated current signal and said rated trip value are defined by constant currents internal to said power switching device, and by at least one rate-setting resistor external to said power switching device.

13. The power switching device according to claim 1, wherein said power switching device performs I²*t protection, with trip time inversely proportional to square of said current signal, for electrical systems connected to said power switching device.

14. A power switching device, said power switching device comprising:
a filament bulb sensing a DC current and an AC current, the resistance of said bulb being dependent on temperature of said filament of said bulb;
a low pass filter connected to said bulb, said low pass filter producing an output DC voltage proportional to said resistance of said bulb;
a trip unit for detecting a trip condition by comparing said output DC voltage with a bulb voltage at a rated current; and
a power switch connected to said bulb, wherein said power switch is shut off when said output DC voltage is larger than said bulb voltage at said rated current.

15. A power switching device, said power switching device comprising:
a sensing unit for sensing a current signal;
an analysis unit for extracting a parameter using a temperature measurement relating to said sensing unit, said parameter being based on a square of said current signal; and
a decision module for detecting a trip condition, said decision module detecting a trip condition by
obtaining a time-integrated value of said parameter in time using an exponential time dependence relating to said parameter, and a thermal inertia associated with at least one of said sensing unit and said analysis unit, and
detecting a trip condition by comparing said time-integrated value with a rated trip value.

16. The power switching device according to claim 15, wherein
said sensing unit comprises a resistor, and
said temperature measurement relating to said sensing unit is a differential temperature measurement between a temperature of said sensing unit obtained by heating said sensing unit with said current signal, and a reference temperature.

17. The power switching device according to claim 15, wherein
said time-integrated value includes a measure for I²*t, wherein I is said current signal and t is time, and
said power switching device performs I²*t protection for electrical systems connected to said power switching device.

18. A method for protection for AC and DC electric systems, said method comprising:
sensing a current signal;
extracting a parameter using a temperature measurement relating to heating caused by said current signal, said parameter being based on a square of said current signal;
integrating said parameter in time, to obtain an integrator value; and
detecting a trip condition by comparing said integrator value with a rated trip value.

19. The method for protection for AC and DC electric systems as recited in claim 18, further comprising:
switching off said current signal, when said detecting step detects a trip condition wherein said integrator value is larger than said rated trip value.

20. The method for protection for AC and DC electric systems as recited in claim 18, further comprising:
detecting gross over-current for said current signal, and
switching off said current signal exhibiting said gross over-current.

21. The method for protection for AC and DC electric systems as recited in claim 18, further comprising:
performing over-temperature protection by detecting an over-temperature condition relating to said current signal, and switching off said current signal.

22. The method for protection for AC and DC electric systems as recited in claim 18, wherein said method protects an electrical system from overload conditions.

23. The method for protection for AC and DC electric systems as recited in claim 18, wherein
said temperature measurement for said extracting step is a differential temperature measurement between a temperature obtained by heating caused by said current signal, and a reference temperature, and
said extracting step extracts a square of said current signal using a proportionality between said differential temperature measurement and said square of said current signal.

24. The method for protection for AC and DC electric systems as recited in claim 18, wherein said integrating step integrates said square of said current signal in time to obtain an integrator value, when said current signal is larger than a rated current signal.

25. The method for protection for AC and DC electric systems as recited in claim 24, wherein said rated current signal and said rated trip value are defined by providing voltage levels derived from a reference voltage.

26. The method for protection for AC and DC electric systems as recited in claim 24, wherein said rated current signal and said rated trip value are defined by constant currents and by at least one rate-setting resistivity value.

27. The method for protection for AC and DC electric systems as recited in claim 18, wherein said method performs I²*t protection, with trip time inversely proportional to square of said current signal.
